(19) United States
(12) Patent Application Publication
(10) Pub. No.: US 2009/0009315 A1
(43) Pub. Date: Jan. 8, 2009

(54) FOLDABLE WARNING DEVICE

(76) Inventors: HSUEH-YEN LIU, Taichung Hsien (TW); Yun-Lung Wei, Taichung City (TW); Yu-Yi Hsu, Changhua Hsien (TW)

Correspondence Address: LEONG C LEI, PMB # 1008, 1867 YGNACIO VALLEY ROAD, WALNUT CREEK, CA, 94598, US

(21) Appl. No.: 11/773,413

(22) Filed: Jul. 4, 2007

(51) Int. Cl. B60Q 1/52

(52) U.S. Cl. 340/471

(57) ABSTRACT

The warning device contains a plastic sheet having a number of through holes and/or a number of magnetic elements positioned alternately along the edges. On a major surface of the plastic sheet, one or more reflective plastic shapes are affixed by high-frequency fusion along which a number of light emitting diodes are arranged beneath and protected by transparent covers. The light emitting diodes draws electricity from a battery or from a cigarette lighter of a vehicle. When the vehicle is broken down, the warning device can be attached to a metallic surface by the magnetic elements, or it can be hanged or tied to something by running a number of threads through the through holes.

### TECHNICAL FIELD OF THE INVENTION

The present invention generally relates to warning devices, and more particularly to a warning device whose main body is a waterproof plastic sheet that can be folded for storage and unfolded for usage.

### DESCRIPTION OF THE PRIOR ART

Conventionally a warning triangle is set up at an appropriate distance along the road behind a broken-down automobile. There are reflection plates affixed to the three elongated boards forming the warning triangle to reflect the headlight of the oncoming vehicles so as to warn them about the potential hazard ahead.

The alarming effect of the conventional warning triangles is limited, especially when the oncoming vehicles are at great speed or when there is not sufficient lighting around such as during the night or in a rainy day. If the headlight of the oncoming vehicles is not turned on or is broken down, the conventional reflection-type warning triangles would be barely visible, therefore providing little, if any, warning to the oncoming vehicles.

### SUMMARY OF THE INVENTION

A novel warning device is provided herein, which contains a waterproof plastic sheet having a number of through holes and/or a number of magnetic elements positioned alternately along the edges of the plastic sheet. On a major surface of the plastic sheet, one or more reflective plastic shapes are affixed by high-frequency fusion along which a number of light emitting diodes (LEDs) are arranged beneath and protected by transparent covers. The LEDs draws electricity from a battery or from a cigarette lighter of a vehicle.

As the main body of the warning device is the plastic sheet, it can be easily folded and saved in the trunk of a vehicle. When the vehicle is broken down, the warning device can be unfolded and attached to a metallic surface by the attraction provided by the magnetic elements, or the warning device can be hanged or tied to something by running a number of threads through the through holes.

The foregoing objectives and summary provided only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a front-view diagram showing a warning device according to an embodiment of the present invention.

FIG. 2 is a front-view diagram showing a warning device according to another embodiment of the present invention.

FIG. 3 is a functional diagram showing an illuminating member of the warning device of the present invention.

FIG. 4 is a front-view diagram showing a warning device according to yet another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments may be made in the function and arrangement of the elements described without departing from the scope of the invention as set forth in the appended claims.

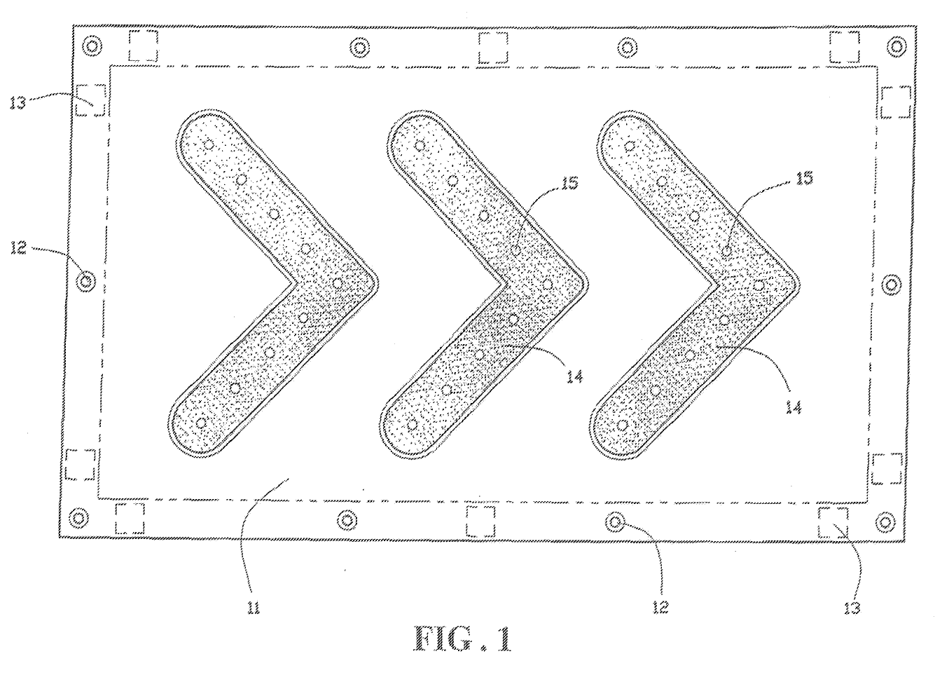

As shown in FIG. 1, the warning device according to an embodiment of the present invention mainly contains a waterproof plastic sheet 11 made of PVC or other similar material. Along the edges of the plastic sheet 11, a number of through holes 12 are provided with appropriate spacing therebetween. Additionally, a number of magnetic elements 13 are also positioned along the edges with appropriate spacing therebetween and sealed inside the plastic sheet 11. On a major surface of the plastic sheet 11, a number of V-shaped reflective plastic stripes 14 are affixed by high-frequency fusion. On each of the stripes 14, a number of transparent covers 15 are provided along the shape of the stripes 14.

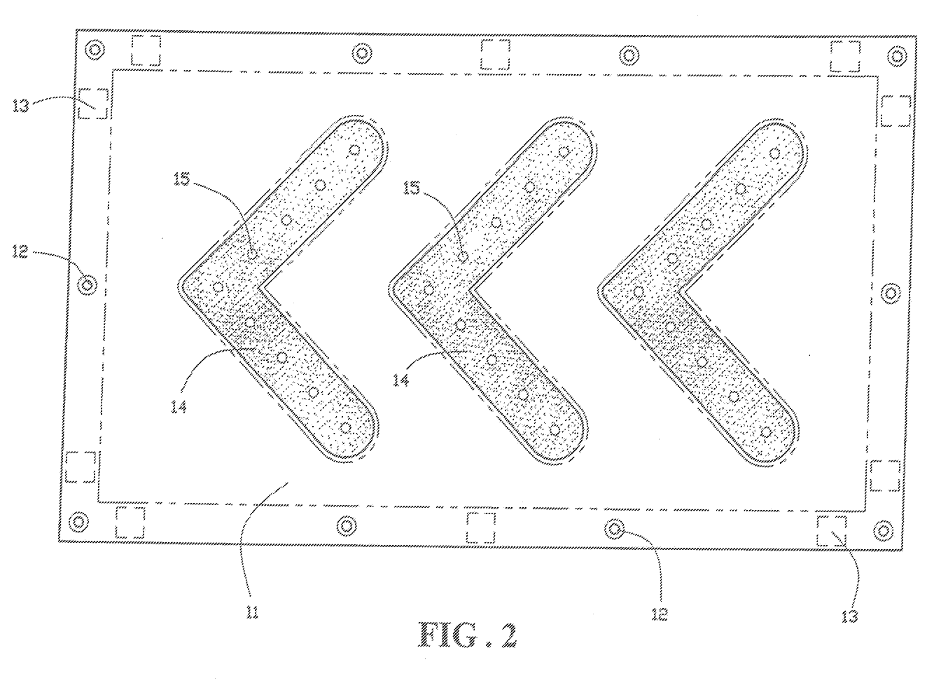

FIG. 2 shows another embodiment of the present invention, which differ from the previous embodiment only in the direction where the stripes 14 point.

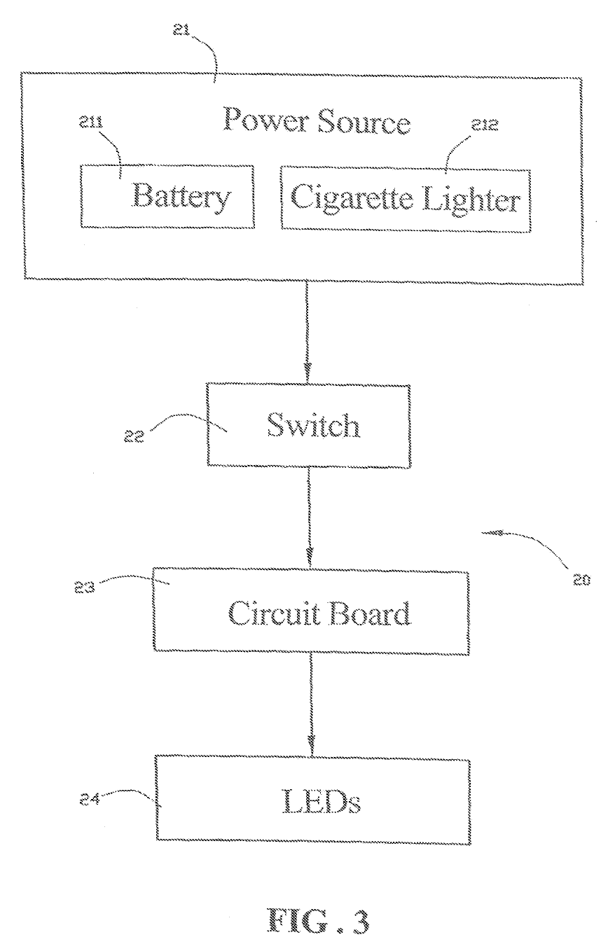

The warning device further contains an illuminating member 20 (not shown) in FIGS. 1 and 2. As depicted in the functional diagram of FIG. 3, the illuminating member 20 contains a power source 21, a switch 22, a circuit board 23, and a number of light emitting diodes (LEDs) 24, series-connected in this order. The power source 21 could be a battery 211 or a plug 212 for plugging into the socket of a cigarette lighter in a vehicle. The switch 22 is a toggle button controlling the provision of electricity from the power source 21 to the circuit board 23. The circuit board 23 has the appropriate programmable ICs to control how the LEDs 24 are turned on and off (i.e., flashed).

The LEDs 24 are positioned beneath and protected by the transparent cover 15 so that their light beams can emanate through. The other elements of the illuminating member 20 are usually separately integrated together, external to the plastic sheet 11. The conduction wires from the circuit board 23 to the LEDs 24 are sealed inside the plastic sheet 11.

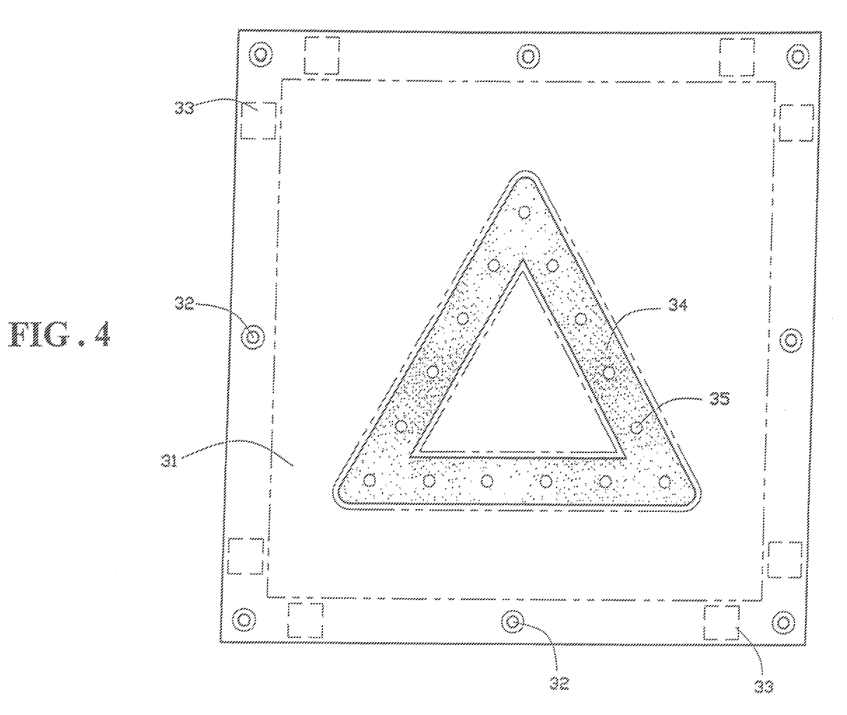

As shown in FIG. 4, another embodiment of the warning device contains a waterproof plastic sheet 31. A number of through holes 32 and a number of magnetic elements 33 are provided alternately along the edges of the plastic sheet 31 with appropriate spacing therebetween. On a major surface of the plastic sheet 31, a reflective plastic triangular shape 34 is affixed by high-frequency fusion. On the triangle 34, a number of transparent covers 35 are provided along the triangular shape 34. The same illuminating member 20 (not shown) is also used here to provide illumination.

As the main body of the warning device is the plastic sheet 11 or 31. The warning device can be easily folded and saved in the trunk of a vehicle, taking up only a minimum amount of space. When the vehicle is broken down, the warning device can be unfolded and attached to a metallic surface by the attraction provided by the magnetic elements 13 or 33, or the warning device can be hanged or tied to something by running a number of threads through the through holes 12 or 32.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A warning device, comprising
a plastic sheet having a plurality of through holes or magnetic elements along the edges of said plastic sheet with appropriate spacing therebetween;
at least a reflective plastic shape affixed to a major surface of said plastic sheet;
a plurality of transparent covers provided on said reflective plastic shape; and
an illuminating member having a plurality of light emitting diodes beneath said transparent covers, said light emitting diodes series-connected to a power source.

2. The warning device according to claim 1, wherein said reflective plastic shape is one of a V shape and a triangular shape.

3. The warning device according to claim 1, wherein said power source is a one of a battery and a plug for plugging into the socket of a cigarette lighter of a vehicle.

4. The warning device according to claim 1, wherein said illuminating member further has a switch series-connected between said light emitting diodes and said power source for turning on and off said light emitting diodes.
